(19) United States
(12) Patent Application Publication
(10) Pub. No.: US 2024/0382900 A1
(43) Pub. Date: Nov. 21, 2024

(54) ELECTROCHEMICAL CELL

(71) Applicant: DENSO CORPORATION, Kariya-city (JP)

(72) Inventors: JUNICHI NARUSE, Kariya-city (JP); GO IIJIMA, Kariya-city (JP)

(21) Appl. No.: 18/626,802

(22) Filed: Apr. 4, 2024

(30) Foreign Application Priority Data
May 15, 2023 (JP) 2023-079964

(51) Int. Cl. B01D 53/32

(52) U.S. Cl. CPC B01D 53/326; B01D 2253/112; B01D 2253/1128; B01D 2257/504; B01D 2258/01; B01D 2258/06

(57) ABSTRACT

An electrochemical cell includes a working electrode, a counter electrode, and an electrolyte covering the working electrode and the counter electrode. The working electrode include a CO₂ adsorbent that is at least one selected from a group consisting of MX₂₋ₐ, MX₂Y_{1-b}, MX₂₋ₐY_{1-b}, M₂C, and M₂C_{1-d}, where M is a transition metal, X is any one selected from a group consisting of S, Se, and Te, Y is an element substituting a part of X, a is within a range of 0<a<2, b is within a range of 0<b<1, and d is within a range of 0<d<1.

### CROSS REFERENCE TO RELATED APPLICATION

The present application claims the benefit of priority from Japanese Patent Application No. 2023-079964 filed on May 15, 2023. The entire disclosure of the above application is incorporated herein by reference.

### TECHNICAL FIELD

The present disclosure relates to an electrochemical cell that adsorbs and desorbs CO₂.

### BACKGROUND

Conventionally, there has been known an electrochemical cell that adsorbs and desorbs CO₂ from a mixed gas containing CO₂ by electrochemical reactions.

### SUMMARY

The present disclosure provides an electrochemical cell for separating CO₂ from a CO₂ containing gas by an electrochemical reaction. The electrochemical cell includes a working electrode including a CO₂ adsorbent, a counter electrode, and an electrolyte covering the working electrode and the counter electrode. The working electrode and the counter electrode are configured so that electrons are supplied from the counter electrode to the working electrode and the working electrode absorbs CO₂ contained in the CO₂ containing gas in response to a first voltage applied between the working electrode and the counter electrode, and electrons are supplied from the working electrode to the counter electrode and the CO₂ is desorbed from the working electrode in response to a second voltage applied between the working electrode and the counter electrode. The CO₂ adsorbent is at least one selected from a group consisting of MX₂₋ₐ, MX₂Y_{1-b}, MX₂₋ₐY_{1-b}, M₂C, and M₂C_{1-d}, where M is a transition metal, X is any one selected from a group consisting of S, Se, and Te, Y is an element substituting a part of X, a is within a range of 0<a<2, b is within a range of 0<b<1, and d is within a range of 0<d<1.

### BRIEF DESCRIPTION OF DRAWINGS

Objects, features and advantages of the present disclosure will become apparent from the following detailed description made with reference to the accompanying drawings. In the drawings:

FIG. 1 is a diagram showing a carbon dioxide recovery system according to an embodiment of the present disclosure;

FIG. 2 is a diagram illustrating a carbon dioxide recovery device;

FIG. 3A is a diagram for explaining the operation of the carbon dioxide recovery device in a CO₂ recovery mode;

FIG. 3B is a diagram for explaining the operation of the carbon dioxide recovery device in a CO₂ discharge mode;

FIG. 4A is a scanning electron microscope (SEM) image of a CO₂ adsorbent with a resolution of 100 μm;

FIG. 4B is a SEM image of the CO₂ adsorbent with a resolution of 1 μm;

FIG. 4C is a SEM image of the CO₂ adsorbent with a resolution of 100 nm;

FIG. 5 is a graph showing the results of measuring CO₂ adsorbents by Raman spectroscopy;

FIG. 6 is a graph showing the results of measuring the CO₂ adsorbents by an X-ray diffraction method;

FIG. 7 is a graph showing the results of composition ratio analysis of the CO₂ adsorbents by energy dispersive X-ray spectroscopy using SEM (SEM-EDX);

FIG. 8 is a diagram showing CO₂ desorption voltages of Examples 1 to 3 and Comparative Examples 1 to 4;

FIG. 9 is a diagram showing CO₂ desorption efficiencies of Examples 1 to 3 and Comparative Examples 1 to 4;

FIG. 10A is a graph showing the relationship between the potential and the electric current when the potential is swept in the negative direction in Example 1 and Comparative Examples 1 and 2;

FIG. 10B is a graph showing the relationship between the potential and the amount of CO₂ in a housing when the potential is swept in the negative direction in Example 1 and Comparative Examples 1 and 2;

FIG. 11A is a graph showing the relationship between the potential and the electric current when the potential is swept in the positive direction in Example 1 and Comparative Examples 1 and 2;

FIG. 11B is a graph showing the relationship between the potential and the amount of CO₂ in the housing when the potential is swept in the positive direction in Example 1 and Comparative Examples 1 and 2;

FIG. 12 is a graph showing the amount of CO₂ in the housing when adsorption and desorption of CO₂ are performed at a constant voltage in Example 1 and Comparative Examples 1 and 2;

FIG. 13 is a graph showing the results of detecting CO₂ in a working electrode by diffuse reflection infrared spectroscopy in Example 1;

FIG. 14 is a graph showing the results of detecting CO₂⁻, C₂O₄²⁻, and HCO₃⁻ in the working electrode by diffuse reflection infrared spectroscopy in Example 1;

FIG. 15A is a graph showing the relationship between the potential and the electric current when the potential is swept in the negative direction in Example 2 and Comparative Examples 3 and 4;

FIG. 15B is a graph showing the relationship between the potential and the amount of CO₂ in a housing when the potential is swept in the negative direction in Example 2 and Comparative Examples 3 and 4;

FIG. 16A is a graph showing the relationship between the potential and the electric current when the potential is swept in the positive direction in Example 2 and Comparative Examples 3 and 4;

FIG. 16B is a graph showing the relationship between the potential and the amount of CO₂ in the housing when the potential is swept in the positive direction in Example 2 and Comparative Examples 3 and 4;

FIG. 17 is a graph showing the amount of CO₂ in the housing when adsorption and desorption of CO₂ are performed at a constant voltage in Example 2 and Comparative Examples 3 and 4;

FIG. 18A is a graph showing the relationship between the potential and the electric current when the potential is swept in a negative direction in Example 3;

FIG. 18B is a graph showing the relationship between the potential and the amount of CO₂ in a housing when the potential is swept in the negative direction in Example 3;

FIG. 19A is a graph showing the relationship between the potential and the electric current when the potential is swept in the positive direction in Example 3;

FIG. 19B is a graph showing the relationship between the potential and the amount of CO₂ in the housing when the potential is swept in the positive direction in Example 3; and

FIG. 20 is a graph showing the amount of CO₂ in the housing when adsorption and desorption of CO₂ are performed at a constant voltage in Example 3.

### DETAILED DESCRIPTION

An electrochemical cell may include polyanthraquinone as a CO₂ adsorbent for adsorbing and desorbing CO₂.

However, when an organic material such as polyanthraquinone is used as the CO₂ adsorbent, it is difficult to increase the density of the CO₂ adsorbent, and an organic compound may be eluted from the electrochemical cell. On the other hand, when an inorganic material is used as the CO₂ adsorbent, an effective catalyst for desorbing CO₂ adsorbed on the CO₂ adsorbent has not been reported, and desorption energy of CO₂ increases.

An electrochemical cell according to an aspect of the present disclosure is for separating CO₂ from a CO₂ containing gas by an electrochemical reaction, and includes a working electrode including a CO₂ adsorbent, a counter electrode, and an electrolyte covering the working electrode and the counter electrode. The working electrode and the counter electrode are configured so that electrons are supplied from the counter electrode to the working electrode and the working electrode absorbs CO₂ contained in the CO₂ containing gas in response to a first voltage applied between the working electrode and the counter electrode, and electrons are supplied from the working electrode to the counter electrode and the CO₂ is desorbed from the working electrode in response to a second voltage applied between the working electrode and the counter electrode. The CO₂ adsorbent is at least one selected from a group consisting of MX₂₋ₐ, MX₂Y_{1-b}, MX₂₋ₐY_{1-b}, M₂C, and M₂C_{1-d}, where M is a transition metal, X is any one selected from a group consisting of S, Se, and Te, Y is an element substituting a part of X, a is within a range of 0<a<2, b is within a range of 0<b<1, and d is within a range of 0<d<1.

In the above-described electrochemical cell, by using at least one selected from the group consisting of MX₂₋ₐ, MX₂Y_{1-b}, MX₂₋ₐ Y_{1-b}, M₂C, and M₂C_{1-d} as the CO₂ adsorbent, CO₂ contained in the CO₂ containing gas is adsorbed to the working electrode in a state of being converted into at least one selected from a group consisting of CO₂⁻, C₂O₄²⁻, and HCO₃⁻. When CO₂⁻, C₂O₄²⁻, and HCO₃⁻ are desorbed from the working electrode, the CO₂ adsorbent acts as a catalyst that promotes reconversion to CO₂. As a result, an electric energy required for CO₂ desorption can be reduced, and CO₂ can be desorbed with low energy.

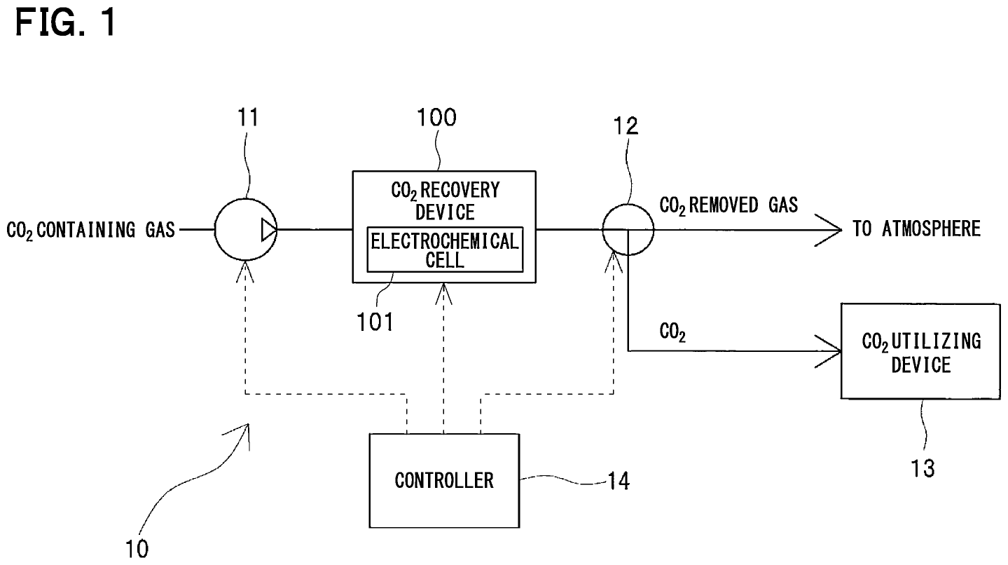

Embodiments of the present disclosure will be described below with reference to the drawings. As shown in FIG. 1, a carbon dioxide recovery system 10 of the present embodiment includes a compressor 11, a carbon dioxide recovery device 100, a passage switching valve 12, a carbon dioxide utilizing device 13, and a controller 14.

The compressor 11 pumps a CO₂ containing gas to the carbon dioxide recovery device 100. The CO₂ containing gas is a mixed gas containing CO₂ and a gas other than CO₂, and for example, the atmosphere or exhaust gas of an internal combustion engine can be used as the CO₂ containing gas.

The carbon dioxide recovery device 100 is a device that separates and recovers CO₂ from the CO₂ containing gas. The carbon dioxide recovery device 100 discharges a CO₂ removed gas that is gas after CO₂ is recovered from the CO₂ containing gas, or CO₂ recovered from the CO₂ containing gas. The configuration of the carbon dioxide recovery device 100 will be described in detail later.

The passage switching valve 12 is a three-way valve that switches a passage of exhaust gas from the carbon dioxide recovery device 100. The passage switching valve 12 switches the passage of the exhaust gas toward the atmosphere when the CO₂ removed gas is discharged from the carbon dioxide recovery device 100, and switches the passage of the exhaust gas toward the carbon dioxide utilizing device 13 when CO₂ is discharged from the carbon dioxide recovery device 100.

The carbon dioxide utilizing device 13 is a device that utilizes CO₂. The carbon dioxide utilizing device 13 may be a storage tank for storing CO₂ or a conversion device for converting CO₂ into fuel. As the conversion device, a device that converts CO₂ into a hydrocarbon fuel such as methane can be used. The hydrocarbon fuel may be gaseous fuel at normal temperature and pressure, or may be liquid fuel at normal temperature and pressure.

The controller 14 includes a well-known microcontroller including a central processing device (CPU), a read only memory (ROM), a random access memory (RAM) and the like, and peripheral circuits thereof. The controller 14 performs various calculations and processes based on control programs stored in the ROM, and controls actuations of various devices connected to an output side of the controller 14. The controller 14 of the present embodiment performs an operation control of the compressor 11, an operation control of the carbon dioxide recovery device 100, a passage switching control of the passage switching valve 12 and the like.

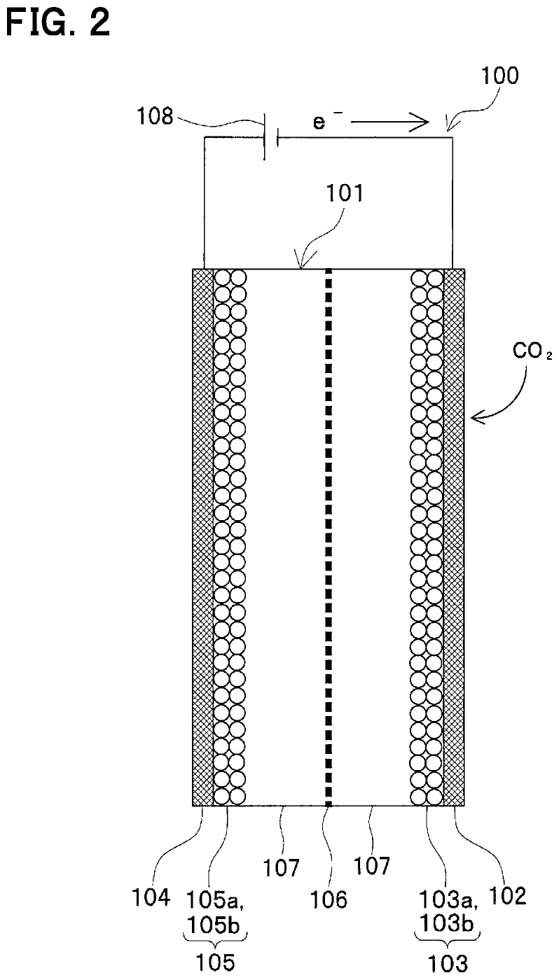

Next, the carbon dioxide recovery device 100 will be described with reference to FIG. 2. As shown in FIG. 2, the carbon dioxide recovery device 100 includes an electrochemical cell 101 configured to adsorb and desorb CO₂ by electrochemical reactions. The electrochemical cell 101 includes a working-electrode current collector 102, a working electrode 103, a counter-electrode current collector 104, a counter electrode 105, an insulating layer 106, and an electrolyte 107. The working-electrode current collector 102, the working electrode 103, the counter-electrode current collector 104, the counter electrode 105, and the insulating layer 106 are laminated.

The electrochemical cell 101 may be housed in a container (not shown). The container may define a gas inlet for introducing the CO₂ containing gas into the container and a gas outlet for discharging the CO₂ removed gas and CO₂ out of the container.

The carbon dioxide recovery device 100 is configured to adsorb and desorb CO₂ by the electrochemical reactions of the electrochemical cell 101, thereby separating and recovering CO₂ from the CO₂ containing gas. The carbon dioxide recovery device 100 includes a power supply 108 that applies a predetermined voltage to the working electrode 103 and the counter electrode 105, and can change a potential difference between the working electrode 103 and the counter electrode 105. The working electrode 103 is a negative electrode, and the counter electrode 105 is a positive electrode.

The electrochemical cell 101 can be switched between a CO₂ recovery mode in which CO₂ is recovered at the working electrode 103 and a CO₂ discharge mode in which CO₂ is discharged from the working electrode 103 by changing the potential difference between the working electrode 103 and the counter electrode 105. The CO₂ recovery mode is a charging mode for charging the electrochemical cell 101, and the CO₂ discharge mode is a discharging mode for discharging the electrochemical cell 101.

In the CO₂ recovery mode, a first voltage V1 is applied between the working electrode 103 and the counter electrode 105, and electrons flows from the counter electrode 105 to the working electrode 103. At the first voltage V1, the counter electrode potential is greater than the working electrode potential. The first voltage V1 may fall within a range from 0.5 to 2.0 V.

In the CO₂ discharge mode, a second voltage V2 is applied between the working electrode 103 and the counter electrode 105, and electrons flows from the working electrode 103 to the counter electrode 105. The second voltage V2 is different from the first voltage V1. The second voltage V2 is a voltage lower than the first voltage V1, and a magnitude relationship between the working electrode potential and the counter electrode potential is not limited. That is, in the CO₂ discharge mode, the working electrode potential may be lower than, equal to, or greater than the counter electrode potential.

The working-electrode current collector 102 is a porous conductive material having pores through which the CO₂ containing gas containing CO₂ can pass. As the working-electrode current collector 102, for example, a carbonaceous material or a metal material can be used. The carbonaceous material constituting the working-electrode current collector 102 may be, for example, carbon paper, carbon cloth, non-woven carbon mat, porous gas diffusion layer (GDL) and the like. The metal material constituting the working-electrode current collector 102 may be, for example, a structure in which a metal such as aluminum (AI), nickel (Ni), stainless steel (SUS), or the like is formed into a mesh shape.

The working electrode 103 includes a working electrode substrate 103a and a CO₂ adsorbent 103b. The working electrode substrate 103a is a conductive material that holds the CO₂ adsorbent 103b. As the working electrode substrate 103a, for example, a carbon sheet can be used. The CO₂ adsorbent 103b is an active material that gives and receives electrons by an oxidation-reduction reaction. The CO₂ adsorbent 103b adsorbs CO₂ by receiving electrons, and desorbs the adsorbed CO₂ by releasing electrons.

In the present embodiment, at least one selected from a group consisting of MX₂₋ₐ, MX₂Y_{1-b}, MX₂₋ₐY_{1-b}, M₂C, and M₂C_{1-d} is used as the CO₂ adsorbent 103b. MX₂₋ₐ, MX₂Y_{1-b}, MX₂₋ₐY_{1-b} are transition metal dichalcogenides, and M₂C and M₂C_{1-d} are transition metal carbides known as “MXenes”.

The transition metal dichalcogenide is a substance in which a transition metal element M and two chalcogen elements X are bonded. The transition metal dichalcogenide has a layered structure in which a transition metal layer is sandwiched between two chalcogen layers.

As the transition metal M of the transition metal dichalcogenide, Group 4 elements, Group 5 elements, Group 6 elements, or Group 7 elements can be used. Specifically, for example, at least one selected from a group consisting of Re, Mo, Ti, Zr, Hf, V, Nb, Ta, and W can be used as the transition metal element M of the transition metal dichalcogenide. As the chalcogen element X of the transition metal dichalcogenide, for example, at least one selected from a group consisting of S, Se, and Te can be used. In the transition metal dichalcogenide, Y is an element substituting a part of X, and for example, nitrogen N can be used. In the present embodiment, at least one selected from a group consisting of ReS₂₋ₐ, ReS₂N_{1-b}, and ReS₂₋ₐN_{1-b} is used as the CO₂ adsorbent 103b made of the transition metal dichalcogenide.

MX₂₋ₐ and MX₂₋ₐY_{1-b} contain defects of chalcogen atoms X in their crystal structures. MX₂Y_{1-b} and MX₂₋ₐY_{1-b} have crystal structures in which a part of chalcogen atoms X is substituted with the different element Y. In MX₂₋ₐ and MX₂₋ₐY_{1-b}, a is in a range of 0<a<2. In MX₂Y_{1-b} and MX₂₋ₐY_{1-b}, b is in a range of 0<b<1.

The transition metal dichalcogenide of the present embodiment includes at least one of a defect of the chalcogen atom X and substitution of the chalcogen atom X with the different element Y in the crystal structure. Thus, the transition metal dichalcogenide of the present embodiment can produce localized electrons.

Transition metal carbides are layered compounds. As the transition metal M of the transition metal carbide, Group 4 elements, Group 5 elements, or Group 6 elements can be used. Specifically, as the transition metal M of the transition metal carbide, for example, at least one selected from a group consisting of Mo, Ti, W, Nb, V, and Zr can be used. M₂C_{1-d} contains defects of carbon atoms C in the crystal structure. In M₂C_{1-d}, d is in a range of 0<d<1. In the present embodiment, Mo₂C is used as the CO₂ adsorbent 103b made of the transition metal carbide.

In the electrochemical cell 101 of the present embodiment, by using at least one of MX₂₋ₐ, MX₂Y_{1-b}, MX₂₋ₐ Y_{1-b}, M₂C, and M₂C_{1-d} as the CO₂ adsorbent 103b, CO₂ is adsorbed to the working electrode 103 in a state of being converted into at least one selected from a group consisting of CO₂⁻, C₂O₄²⁻, and HCO₃⁻. When CO₂⁻, C₂O₄²⁻, and HCO₃⁻ are desorbed from the working electrode 103, they are converted into CO₂. In the present embodiment, CO₂ is adsorbed on the working electrode 103 in the state of CO₂⁻, C₂O₄²⁻, and HCO₃⁻. When CO₂⁻, C₂O₄²⁻, and HCO₃⁻ are desorbed from the working electrode 103, the CO₂ adsorbent acts as a catalyst that promotes reconversion to CO₂, and CO₂⁻, C₂O₄²⁻, and HCO₃⁻ can be desorbed from the working electrode 103 with low energy.

The working electrode 103 may further include a conductive assistant and a binder. The conductive assistant forms a conductive path to the CO₂ adsorbent 103b. For the conductive assistant, for example, a carbon material such as carbon nanotube, carbon black, or graphene can be used. The binder may be a material that can hold the CO₂ adsorbent 103b on the working electrode substrate 103a and has conductivity. The binder may be a conductive resin such as an epoxy resin and a fluoropolymer, containing Ag or the like as a conductive filler. The fluoropolymer may be, for example, polytetrafluoroethylene (PTFE), or polyvinylidene fluoride (PVDF).

The counter-electrode current collector 104 is a conductive material. As the counter-electrode current collector 104, the same material as that of the working-electrode current collector 102 described above can be used.

The counter electrode 105 includes a counter electrode substrate 105a and a counter electrode active material 105b. The counter electrode substrate 105a is a conductive material that holds the counter electrode active material 105b. As the counter electrode substrate 105a, for example, a carbon sheet can be used. The counter electrode active material 105b is an auxiliary electroactive species that exchanges electrons with the working electrode 103.

The counter electrode active material 105b is an active material that gives and receives electrons by an oxidation-reduction reaction. The counter electrode active material 105b may be, for example, a metal complex that can receive and release electrons by changing a valence of a metal ion. Examples of such a metal complex include cyclopentadienyl metal complexes such as ferrocene, nickelocene, and cobaltocene, porphyrin metal complexes, and the like. These metal complexes may be polymers or monomers. In the present embodiment, polyvinyl ferrocene is used as the counter electrode active material 105b. Ferrocene transfers electrons by changing the valence of Fe between divalent an trivalent.

The counter electrode 105 may further include a conductive assistant and a binder. The conductive assistant and the binder of the counter electrode 105 may be the same as the conductive assistant and the binder of the working electrode 103 described above.

The insulating layer 106 is disposed between the working electrode 103 and the counter electrode 105, and separates the working electrode 103 and the counter electrode 105 from each other. The insulating layer 106 is an insulating ion permeable membrane that prevents physical contact between the working electrode 103 and the counter electrode 105 to restrict an electrical short circuit and that allows ions to permeate therethrough.

As the insulating layer 106, a separator or a gas layer such as air can be used. In the present embodiment, a porous separator is used as the insulating layer 106. As the material of the separator, a cellulose membrane, a polymer, a composite material of a polymer and a ceramic, or the like can be used.

An electrolyte 107 having ionic conductivity is provided between the working electrode 103 and the counter electrode 105. The electrolyte 107 is provided between the working electrode 103 and the counter electrode 105 via the insulating layer 106. The electrolyte 107 is provided to cover the working electrode 103, the counter electrode 105 and the insulating layer 106.

In the present embodiment, an aprotic electrolyte is used as the electrolyte 107. The aprotic electrolyte is an electrolyte that does not donate protons (H⁺). Therefore, charges do not move to the electrolyte 107 due to proton generation, and the decrease in current efficiency during CO₂ adsorption can be restricted.

An ionic liquid can be used as the electrolyte 107 having an aprotic property. The ionic liquid is a salt of a liquid having non-volatility under normal temperature and pressure. When the ionic liquid is used as the electrolyte 107, the ionic liquid may be gelled to prevent elution of the ionic liquid from the electrochemical cell 101. As the ionic liquid having an aprotic property, [BMIM][TFSI], [TMPA][TFSI], [Pyrro][TFSI], [BMIM][Tfb], [EMIM][TFSI], or the like can be used.

The ionic liquid of the present embodiment does not contain small ions such as lithium ions and sodium ions, and cations of the ionic liquid form weak ion pairs with the working electrode 103. Therefore, the interaction between CO₂⁻, C₂O₄²⁻, and HCO₃⁻ adsorbed to the working electrode 103 and the cations contained in the ionic liquid can be reduced, the desorption power of CO₂ can be reduced, and CO₂ can be desorbed with low energy.

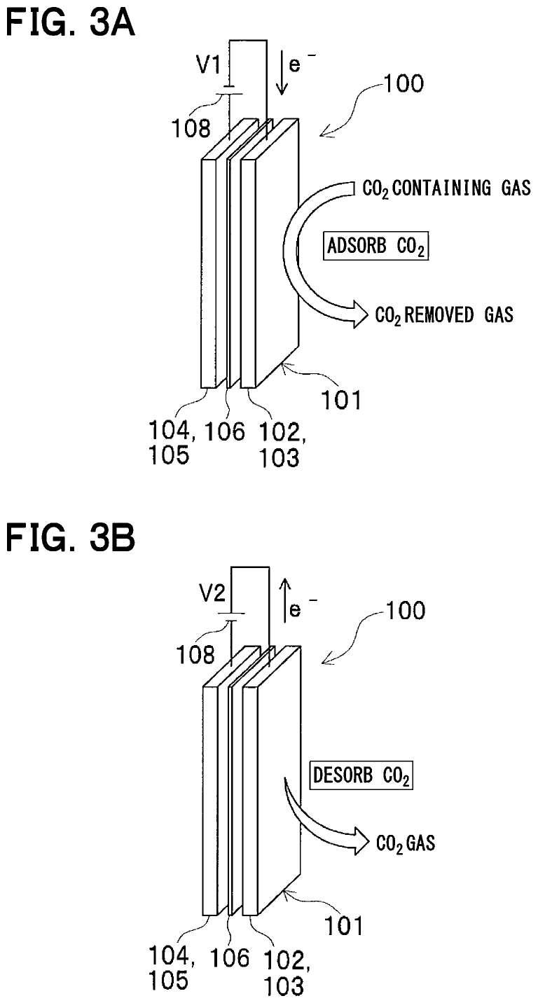

Next, an operation of the carbon dioxide recovery system 10 of the present embodiment will be described. The carbon dioxide recovery system 10 operates by alternately switching between the CO₂ recovery mode shown in FIG. 3A and the CO₂ discharge mode shown in FIG. 3B. The operation of the carbon dioxide recovery system 10 is controlled by the controller 14.

First, the CO₂ recovery mode will be described. In the CO₂ recovery mode, the compressor 11 operates to supply the CO₂ containing gas to the carbon dioxide recovery device 100. In the carbon dioxide recovery device 100, the voltage applied between the working electrode 103 and the counter electrode 105 is the first voltage V1. This makes it possible to simultaneously realize electron donation of the counter electrode 105 and electron attraction of the working electrode 103.

The counter electrode active material 105b of the counter electrode 105 discharges electrons to be oxidized, and the electrons are supplied from the counter electrode 105 to the working electrode 103. The CO₂ adsorbent 103b of the working electrode 103 receives electrons and adsorbs CO₂. In the present embodiment, CO₂ is adsorbed to the working electrode 103 in a state of being converted into at least one selected from a group consisting of CO₂⁻, C₂O₄²⁻, and HCO₃⁻. Thus, the carbon dioxide recovery device 100 can recover CO₂ from the CO₂ containing gas.

After CO₂ is recovered from the CO₂ containing gas by the carbon dioxide recovery device 100, the CO₂ containing gas is discharged from the carbon dioxide recovery device 100 as the CO₂ removed gas containing no CO₂. The passage switching valve 12 switches the passage of exhaust gas toward the atmosphere, and the CO₂ removed gas from the carbon dioxide recovery device 100 is discharged to the atmosphere.

Next, the CO₂ discharge mode will be described. In the CO₂ discharge mode, the compressor 11 is stopped and supply of the CO₂ containing gas to the carbon dioxide recovery device 100 is stopped. In the carbon dioxide recovery device 100, the voltage applied between the working electrode 103 and the counter electrode 105 is the second voltage V2. As a result, electron donation of the CO₂ adsorbent 103b of the working electrode 103 and electron attraction of the counter electrode active material 105b of the counter electrode 105 can be realized at the same time.

The CO₂ adsorbent 103b desorbs and releases CO₂. CO₂⁻, C₂O₄²⁻, and HCO₃⁻ adsorbed by the CO₂ adsorbent 103b are desorbed in a state of being converted into CO₂.

The CO₂ from the CO₂ adsorbent 103b is discharged from the carbon dioxide recovery device 100. The passage switching valve 12 switches the passage of the exhaust gas toward the carbon dioxide utilizing device 13, and the CO₂ discharged from the carbon dioxide recovery device 100 is supplied to the carbon dioxide utilizing device 13.

In the present embodiment, at least one selected from the group consisting of MX₂₋ₐ, MX₂Y_{1-b}, MX₂₋ₐ Y_{1-b}, M₂C, and M₂C_{1-d} is used as the CO₂ adsorbent 103b of the working electrode 103. Therefore, in the CO₂ recovery mode, CO₂ contained in the CO₂ containing gas is adsorbed to the working electrode 103 in a state of being converted into at least one selected from the group consisting of CO₂⁻, C₂O₄²⁻, and HCO₃⁻. When CO₂⁻, C₂O₄²⁻, and HCO₃⁻ are desorbed from the working electrode 103, the CO₂ adsorbent acts as a catalyst that promotes reconversion to CO₂, and the electrical energy required for CO₂ desorption can be reduced, and CO₂ can be desorbed with low energy.

In the present embodiment, the aprotic ionic liquid is used as the electrolyte 107. Since the aprotic ionic liquid does not contain small ions such as lithium ions and sodium ions, the interaction between CO₂⁻, C₂O₄²⁻, and HCO₃⁻ adsorbed to the working electrode 103 and cations contained in the ionic liquid can be reduced. As a result, the desorption power of CO₂ can be reduced, and CO₂ can be desorbed with low energy.

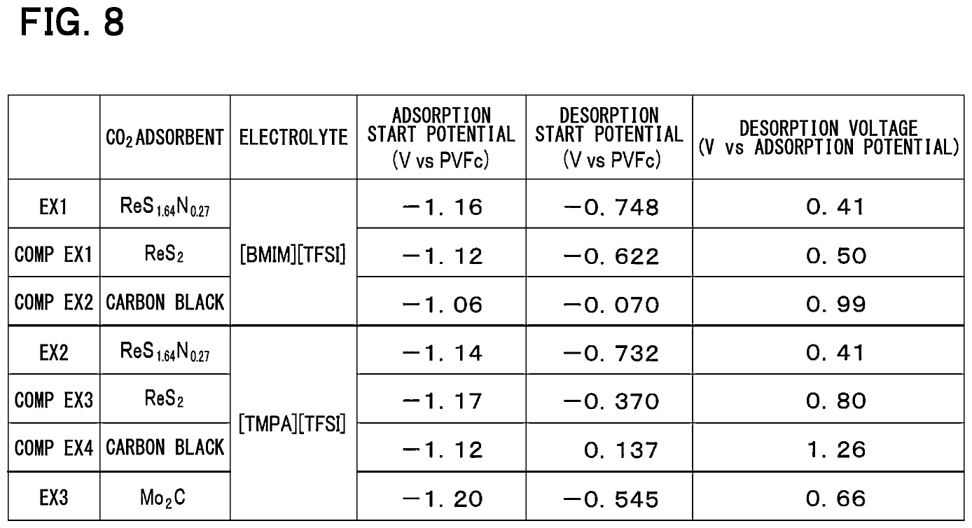

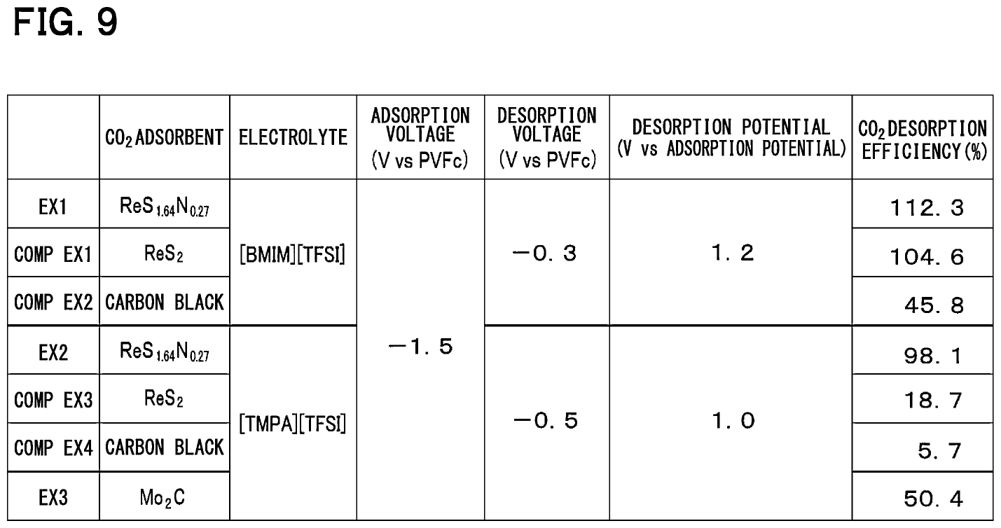

Next, Examples 1 to 3 of the present disclosure will be described. Example 1 will be described together with Comparative Examples 1 and 2, and Example 2 will be described together with Comparative Examples 3 and 4. FIG. 8 shows desorption voltages (desorption energies) of Examples (EX) 1 to 3 and Comparative Examples (COMP EX) 1 to 4. FIG. 9 shows CO₂ desorption efficiencies of Examples 1 to 3 and Comparative Examples 1 to 4.

### Example 1

Example 1 of the present disclosure will be described. In the electrochemical cell 101 of Example 1, ReS_{1.64}N_{0.27} was used as the CO₂ adsorbent 103b, and [BMIM][TFSI] was used as the electrolyte 107. In the electrochemical cell 101 of Comparative Example 1, ReS₂ was used as the CO₂ adsorbent 103b, and [BMIM][TFSI] was used as the electrolyte 107. In the electrochemical cell 101 of Comparative Example 2, carbon black was used as the CO₂ adsorbent 103b, and [BMIM][TFSI] was used as the electrolyte 107.

A method of producing the working electrode 103 of Example 1 will be described. ReS_{1.64}N_{0.27} used as the CO₂ adsorbent 103b of Example 1 is a transition metal dichalcogenide containing defects of S elements bonded to Re elements and substitution of S elements with N elements.

First, a carbon sheet (H-060 manufactured by Toray Industries, Inc.) was placed in a crucible and heated in the atmosphere at 700° C. for 10 minutes. The carbon sheet was used as the working electrode substrate 103a.

Next, ammonium perrhenate NH₄ReO₄ (171 mg), thioacetamide CH₃CSNH₂ (336 mg), and urea CO(NH₂)₂ (518 mg) were dispersed in water and stirred for 30 minutes to produce a dispersion liquid.

Next, the dispersion liquid and the carbon sheet were placed in a sealed container and heated at 200° C. for 20 hours, and then the carbon sheet was taken out from the sealed container and washed with water. As a result, ReS_{1.64}N_{0.27} could be generated on a surface of the carbon sheet, and the working electrode 103 of Example 1 could be produced.

Next, a method of producing the working electrode 103 of Comparative Example 1 will be described. ReS₂ used as the CO₂ adsorbent 103b of Comparative Example 1 is a transition metal dichalcogenide that does not include defects of S elements bonded to Re elements and substitution of S elements with N elements.

First, a carbon sheet (H-060 manufactured by Toray Industries, Inc.) was placed in a crucible and heated in the atmosphere at 700° C. for 10 minutes. Next, sodium perrhenate NaReO₄ (174 mg) and sodium sulfide nonahydrate Na₂S·9H₂O (1076 mg) were dispersed in water and stirred for 30 minutes to produce a dispersion liquid.

Next, the dispersion liquid and the carbon sheet were placed in a sealed container and heated at 200° C. for 20 hours, and then the carbon sheet was taken out from the sealed container and washed with water. As a result, ReS₂ could be generated on a surface of the carbon sheet, and the working electrode 103 of Comparative Example 1 could be produced.

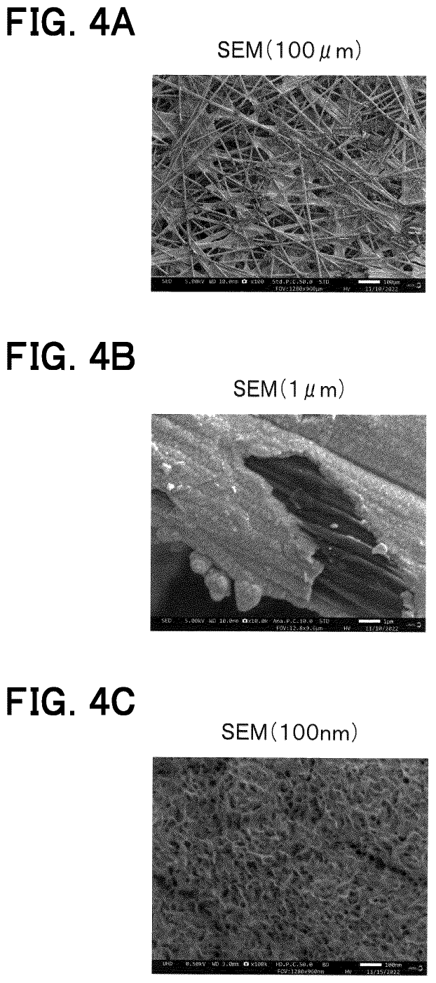

FIG. 4A to FIG. 4C are SEM images of ReS_{1.64}N_{0.27} produced by the production method described above. ReS₂ produced by the production method described above exhibited the appearance similar to ReS_{1.64}N_{0.27}. The SEM images in FIGS. 4A to 4C have different resolutions. The SEM image in FIG. 4A has a resolution of 100 μm, the SEM image in FIG. 4B has a resolution of 1 μm, and the SEM image in FIG. 4C has a resolution of 100 nm.

As shown in FIG. 4A and FIG. 4B, ReS₂ is formed on the surface of the fibrous carbon sheet. The ReS₂ is in a state of being formed as a film on the surface of the carbon sheet. As shown in FIG. 4C, the ReS₂ is formed in a flake shape (that is, a petal shape).

Next, the results of analyzing the products produced by the above-described production methods will be described.

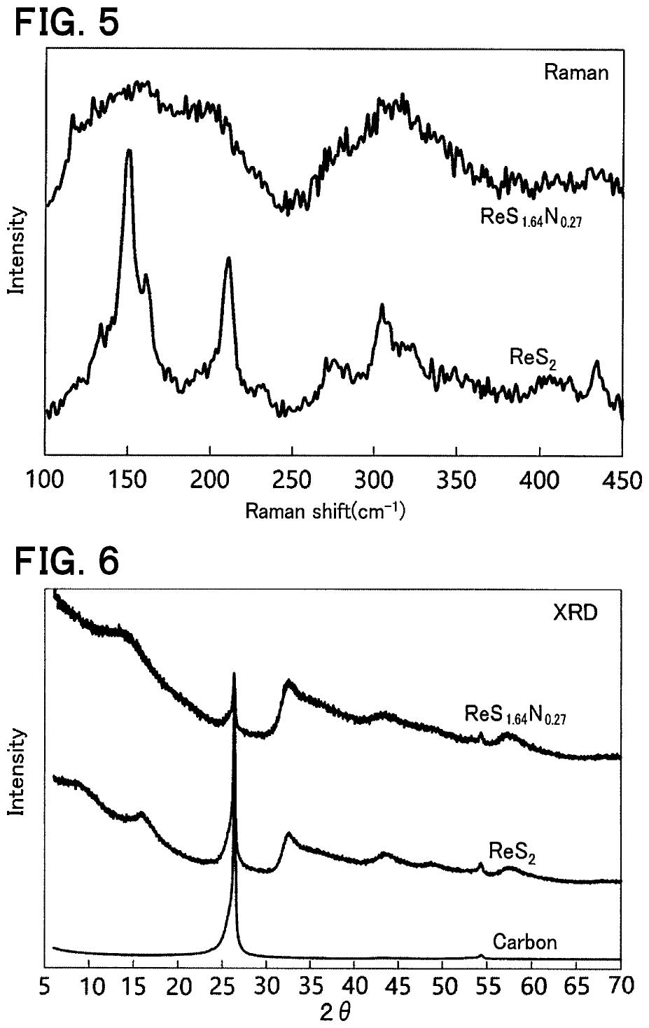

FIG. 5 shows Raman spectra obtained by measuring the products produced by the above-described production methods by Raman spectroscopy. FIG. 6 shows X-ray diffraction (XRD) spectra obtained by measuring the products produced by the above-described production methods by XRD. FIG. 6 also shows an XRD spectrum of carbon. In the Raman spectra shown in FIG. 5 and the XRD spectra shown in FIG. 6, spectra showing characteristics of ReS_{1.64}N_{0.27} and ReS₂ were obtained.

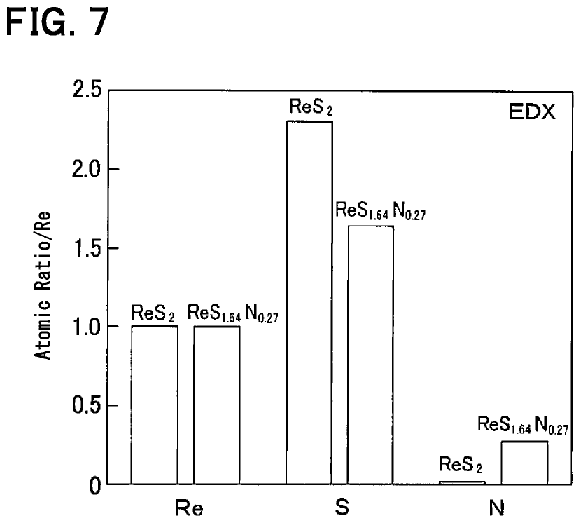

FIG. 7 shows the results of composition ratio analysis by energy dispersive X-ray spectroscopy (SEM-EDX) of the products produced by the above-described production methods. The SEM-EDX analysis was performed by averaging five points. As shown in FIG. 7, as a result of the SEM-EDX analysis, Re, S, and N contained in the products obtained by the above-described production methods had composition ratios corresponding to ReS_{1.64}N_{0.27} and ReS₂.

From the above analysis results, it was confirmed that ReS_{1.64}N_{0.27} and ReS₂ were produced by the above-described production methods.

Next, a method of producing the working electrode 103 of Comparative Example 2 will be described. In the electrochemical cell 101 of Comparative Example 2, the working electrode 103 can be obtained by supporting carbon black (DENKA BLACK Li Li400) on a carbon sheet (H-060 manufactured by Toray Industries, Inc.).

Next, a method of producing the counter electrode 105 of each of Example 1 and Comparative Examples 1 and 2 will be described.

First, 30 mg of polyvinyl ferrocene powder manufactured by NARD Institute, Ltd. was dispersed in N-methyl-2-pyrrolidone, and the dispersion liquid was stirred with a homogenizer for 20 minutes. Polyvinyl ferrocene was used as the counter electrode active material 105b.

Subsequently, 30 mg of multi-walled carbon nanotube (CNT) was added to the dispersion liquid, and the mixture was stirred with a homogenizer for 30 minutes. Thereafter, the dispersion liquid was applied to a carbon sheet (H-060 manufactured by Toray Industries, Inc.) and dried. The carbon sheet was used as the counter electrode substrate 105a, and the multi-walled CNT was used as the conductive assistant of the counter electrode 105. Accordingly, the counter electrode 105 using polyvinyl ferrocene as the counter electrode active material 105b was obtained.

In the electrochemical cells 101 of Example 1 and Comparative Examples 1 and 2, a SUS mesh material was used as the working-electrode current collector 102 and the counter-electrode current collector 104, and a separator manufactured by Whatman was used as the insulating layer 106.

The working electrode 103, the counter electrode 105, and the insulating layer 106 obtained in the above-described production methods were immersed in [BMIM][TFSI] used as the electrolyte 107, and the working-electrode current collector 102, the working electrode 103, the insulating layer 106, the counter electrode 105, and the counter-electrode current collector 104 were laminated in this order. Accordingly, the electrochemical cells 101 of Example 1 and Comparative Examples 1 and 2 were obtained.

Next, measurement results of an adsorption start potential, a desorption start potential, and a desorption efficiency when CO₂ adsorption and desorption are performed in each of the electrochemical cells 101 of Example 1, Comparative Example 1, and Comparative Example 2 will be described.

The adsorption start potential, the desorption start potential, and the desorption efficiency were measured by the following procedure. The electrochemical cell 101 to be measured was placed in a housing, the inside of the housing was purged using a mixed gas of O₂/N₂, and then a mixed gas of CO₂/O₂ was introduced to adjust a CO₂ concentration to 1200±200 ppm. Thereafter, the housing was sealed, and electrochemical measurements were performed.

For the electrochemical measurements, an electrochemical measurement apparatus 1255WB manufactured by Solartron Analytical was used. The CO₂ adsorption start potential and the CO₂ desorption start potential were measured by potential sweeping by a cyclic voltammetry measurement. In the cyclic voltammetry measurement, the potential was swept at 1 mV/s in a potential range of −1.6 V to 1.0 V. For the CO₂ desorption efficiency, adsorption and desorption of CO₂ were performed by applying a constant voltage to the electrochemical cell 101.

The amount of CO₂ recovered by the electrochemical cell 101 was measured by measuring the amount of CO₂ in the housing with a CO₂ sensor. In the present disclosure, the amount of CO₂ in the housing accommodating the electrochemical cell 101 is referred to as “the amount of CO₂ in the housing”.

When CO₂ adsorption by the electrochemical cell 101 is performed in the housing, the amount of CO₂ in the housing decreases. When CO₂ desorption by the electrochemical cell 101 is performed in the housing, the amount of CO₂ in the housing increases. Therefore, the decrease amount of the CO₂ amount in the housing corresponds to the CO₂ adsorption amount of the electrochemical cell 101, and the increase amount of the CO₂ amount in the housing corresponds to the CO₂ desorption amount of the electrochemical cell 101.

The CO₂ recovery amount is the amount of CO₂ adsorbed in the electrochemical cell 101. The decrease amount of the CO₂ amount in the housing corresponds to the increase amount of the CO₂ recovery amount, and the decrease amount of the CO₂ amount in the housing corresponds to the increase amount of the CO₂ recovery amount.

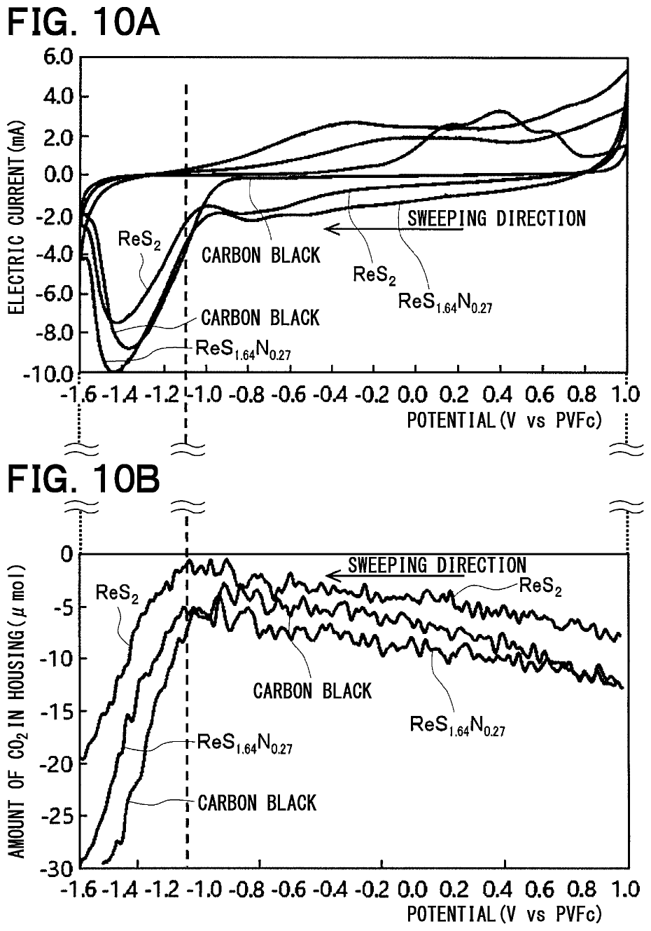

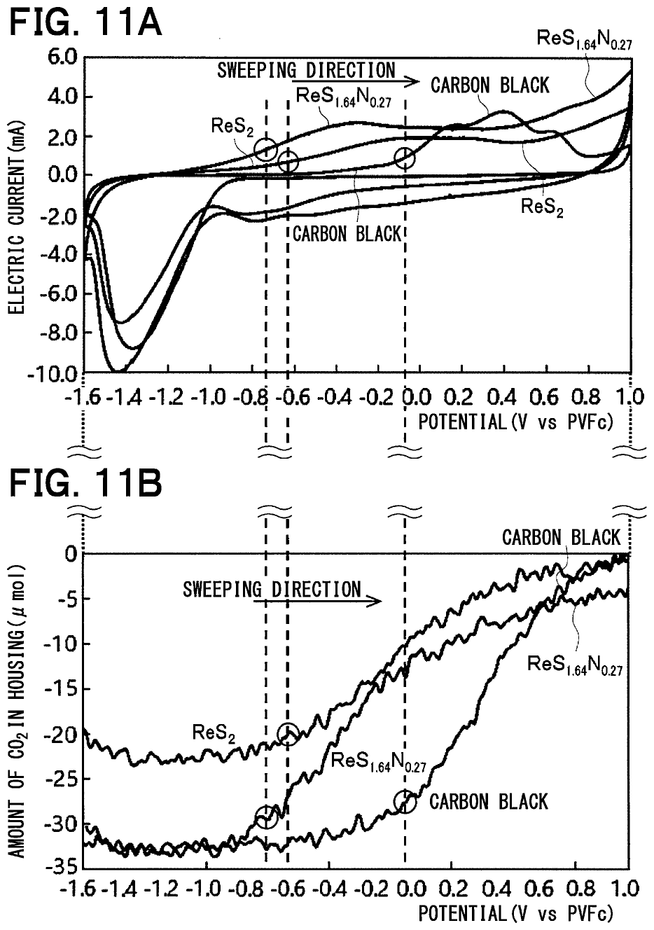

FIGS. 10A and 10B and FIGS. 11A and 11B show changes in the electric current (mA) and the amount of CO₂ (μmol) in the housing when potential sweep was performed in cyclic voltammetry measurement for the electrochemical cells 101 of Example 1 and Comparative Examples 1 and 2. FIG. 10A and FIG. 11A show CV curves showing the change in the electric current when the potential was swept. FIG. 10B and FIG. 11B show the change in the amount of CO₂ in the housing when the potential was swept, that is, the change in the amount of CO₂ adsorbed by the electrochemical cell 101. The change in the amount of CO₂ in the housing is a change in the amount of CO₂ recovered by the electrochemical cell 101, and means the change in the amount of absorbed CO₂ or the change in the amount of desorbed CO₂ in the electrochemical cell 101.

FIG. 10A and FIG. 10B shows the change in the electric current and the amount of CO₂ in the housing, that is, the change in the CO₂ recovery amount when the potential was swept in the negative direction, and the potential changes from the right to the left in FIG. 10A and FIG. 10B. In FIG. 10A, the potentials corresponding to points where the electric current values change greatly are the adsorption start potentials.

FIG. 11A and FIG. 11B shows the change in the electric current and the amount of CO₂ in the housing, that is, the change in the CO₂ recovery amount when the potential was swept in the positive direction, and the potential changes from the left to the right in FIG. 11A and FIG. 11B. In FIG. 11A, the potentials corresponding to points where the electric current values change greatly are the desorption start potentials.

As shown in FIG. 8 and FIG. 10A, the adsorption start potential was-1.16 V in Example 1, −1.12 V in Comparative Example 1, and −1.06 V in Comparative Example 2. As shown in FIG. 8 and FIG. 11A, the desorption start potential was −0.748 V in Example 1, −0.622 V in Comparative Example 1, and −0.070 V in Comparative Example 2.

The desorption voltage shown in FIG. 8 is a potential difference between the adsorption start potential and the desorption start potential. The desorption voltage is electric energy (desorption energy) required for desorption of CO₂. As shown in FIG. 8, the desorption voltage was 0.41 V in Example 1, 0.50 V in Comparative Example 1, and 0.99 V in Comparative Example 2. In Example 1 and Comparative Example 1, CO₂ desorption started at a lower voltage than in Comparative Example 2. Especially, in Example 1, CO₂ desorption could be performed at a low voltage.

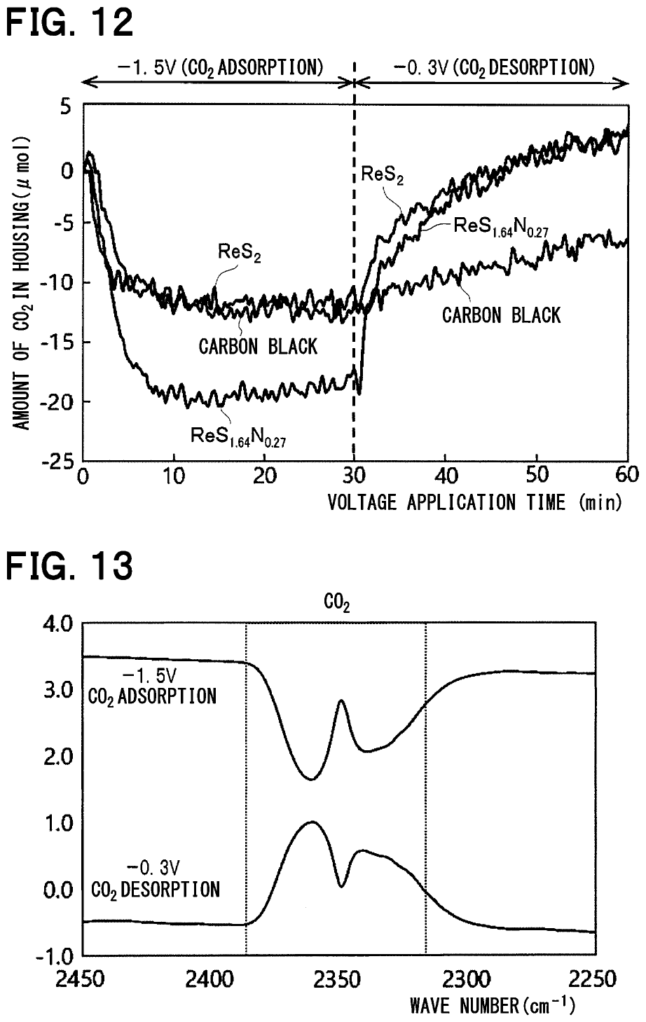

Next, the results of measuring the CO₂ desorption efficiency of each of the electrochemical cells 101 of Example 1 and Comparative Examples 1 and 2 will be described. FIG. 12 shows the amount of CO₂ in the housing when CO₂ adsorption is performed at a constant adsorption voltage and then CO₂ desorption is performed at a constant desorption voltage on each of the electrochemical cells 101 of Example 1 and Comparative Examples 1 and 2. The adsorption voltage was −1.5 V, the desorption voltage was −0.3 V, and the adsorption time and the desorption time were each 30 minutes.

As shown in FIG. 12, when CO₂ adsorption was performed at the constant adsorption voltage (−1.5 V), the amount of CO₂ in the housing decreased in all of Example 1, Comparative Example 1, and Comparative Example 2. That is, it is considered that CO₂ adsorption was performed in all of Example 1, Comparative Example 1, and Comparative Example 2.

Next, when CO₂ desorption was performed at the constant desorption voltage (−0.3 V), the amount of CO₂ in the housing significantly increased in Example 1 and Comparative Example 1, but the amount of CO₂ in the housing slowly increased in Comparative Example 2. That is, it is considered that in Example 1 and Comparative Example 1, the adsorbed CO₂ could be efficiently desorbed, and the amount of CO₂ in the housing was significantly increased, whereas in Comparative Example 2, the adsorbed CO₂ could not be sufficiently desorbed, and the amount of CO₂ in the housing was slowly increased.

Here, the CO₂ desorption efficiency of Example 1, Comparative Example 1, and Comparative Example 2 will be described. The CO₂ desorption efficiency (%) is a value obtained by dividing the CO₂ desorption amount by the CO₂ adsorption amount and expressed in percentage. As shown in FIG. 9, the CO₂ desorption efficiency was 112.3% in Example 1, 104.6% in Comparative Example 1, and 45.8% in Comparative Example 2. That is, Example 1 and Comparative Example 1 could obtain higher CO₂ desorption efficiency than Comparative Example 2. Especially, in Example 1, high CO₂ desorption efficiency could be obtained.

Next, gas species present in the working electrode 103 when CO₂ adsorption and CO₂ desorption are performed in Example 1 will be described. A constant adsorption voltage (−1.5 V) was applied to the electrochemical cell 101 during CO₂ adsorption, and a constant desorption voltage (−0.3 V) was applied to the electrochemical cell 101 during CO₂ desorption.

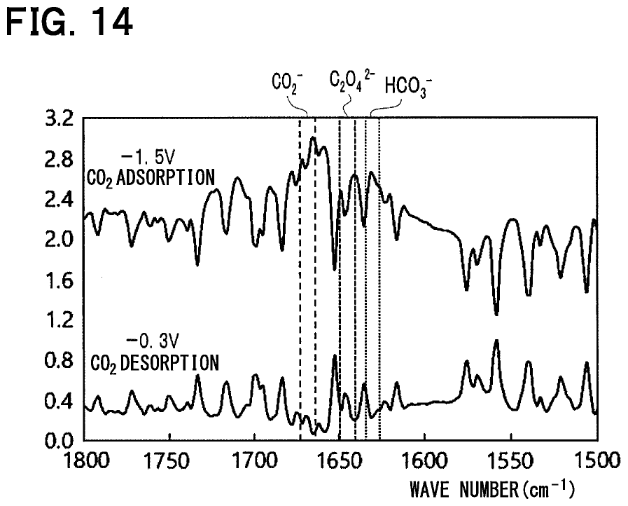

FIG. 13 and FIG. 14 show the results of detecting gas in an electrolytic solution in the working electrode and at the interface between the electrolytic solution and the CO₂ adsorbent by diffuse reflectance infrared spectroscopy (DRIFT method). The ranges of wave number are different between FIG. 13 and FIG. 14. In FIG. 13, a range sandwiched by broken lines corresponds to CO₂. In FIG. 14, three ranges sandwiched by broken lines respectively correspond to CO₂⁻, HCO₃⁻, and C₂O₄²⁻ from the left.

As shown in FIG. 13, when a constant adsorption voltage (−1.5 V) was applied to the electrochemical cell 101, the intensity of the spectrum at the wave number corresponding to CO₂ decreased. On the other hand, as shown in FIG. 14, when the constant adsorption voltage (−1.5 V) was applied to the electrochemical cell 101, peaks corresponding to CO₂⁻, HCO₃⁻, and C₂O₄²⁻ were confirmed.

From the analysis results of FIG. 13 and FIG. 14, it is considered that at the time of CO₂ adsorption, CO₂ is adsorbed by the working electrode 103 and then converted into CO₂⁻, HCO₃⁻, and C₂O₄²⁻ having different compositions. That is, it is considered that CO₂ is adsorbed on the working electrode 103 in a state of at least one selected from the group consisting of CO₂⁻, HCO₃⁻, and C₂O₄²⁻.

As shown in FIG. 13, when the constant desorption voltage (−0.3 V) was applied to the electrochemical cell 101, the intensity of the spectrum at the wave number corresponding to CO₂ increased. On the other hand, as shown in FIG. 14, when the constant desorption voltage (−0.3 V) was applied to the electrochemical cell 101, the peaks corresponding to CO₂⁻, HCO₃⁻, and C₂O₄²⁻ disappeared.

From the analysis results of FIG. 13 and FIG. 14, it is considered that, at the time of CO₂ desorption, CO₂⁻, HCO₃⁻, and C₂O₄²⁻ adsorbed on the working electrode 103 are converted into CO₂ and desorbed from the working electrode 103 in the state of CO₂.

### Example 2

Next, Example 2 of the present disclosure will be described. Example 2, Comparative Example 3, and Comparative Example 4 are different from Example 1, Comparative Example 1, and Comparative Example 2 in that [TMPA][TFSI] was used as the electrolyte 107.

In Example 2, ReS_{1.64}N_{0.27} was used as the transition metal chalcogenide used in the CO₂ adsorbent 103b. In Comparative Example 3, ReS₂ was used as the CO₂ adsorbent 103b. In Comparative Example 4, carbon black was used as the CO₂ adsorbent 103b.

Next, measurement results of an adsorption start potential, a desorption start potential, and a desorption efficiency when CO₂ adsorption and desorption are performed in each of the electrochemical cells 101 of Example 2, Comparative Example 3, and Comparative Example 4 will be described. The adsorption start potential, the desorption start potential, and the desorption efficiency were measured in the same manner as in Example 1.

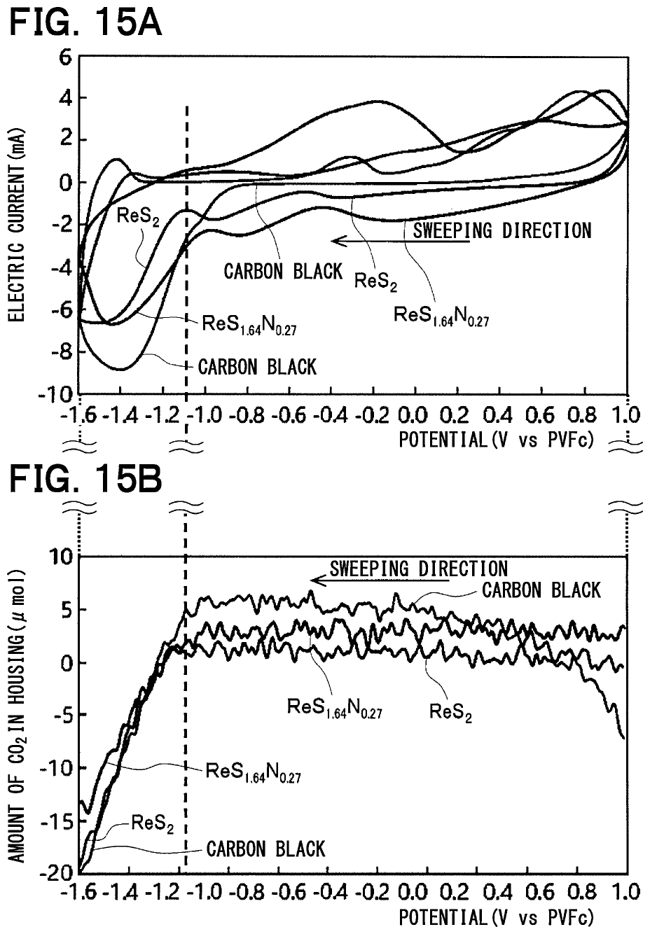

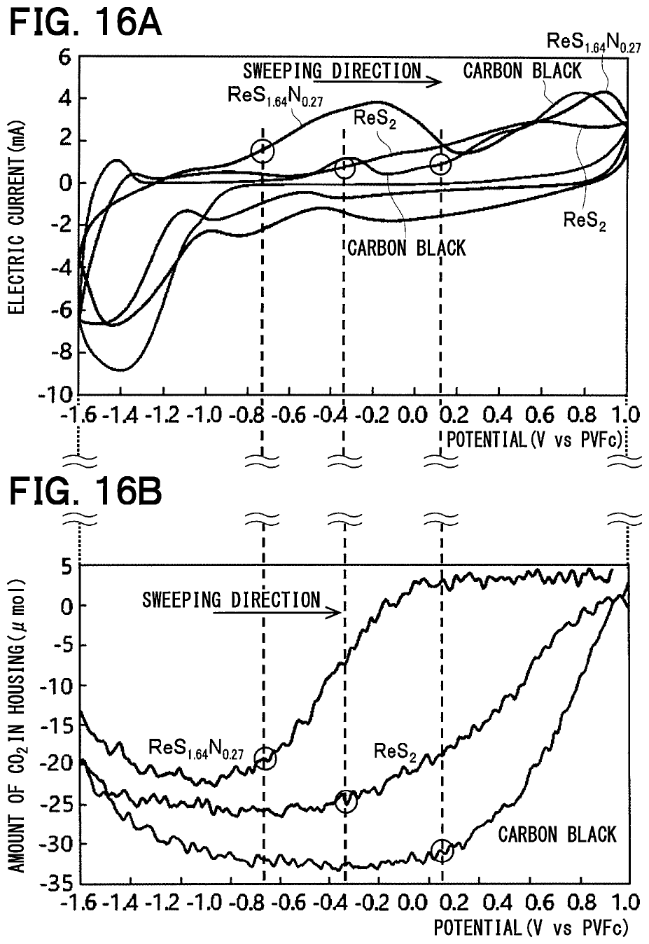

FIGS. 15A and 15B and FIGS. 16A and 16B show changes in the electric current (mA) and the amount of CO₂ (μmol) in the housing when potential sweep was performed in cyclic voltammetry measurement for the electrochemical cells 101 of Example 2 and Comparative Examples 3 and 4. FIG. 15A and FIG. 16A show CV curves showing the change in the electric current when the potential was swept. FIG. 15B and FIG. 16B show the change in the amount of CO₂ in the housing when the potential was swept. FIGS. 15A and 15B and FIGS. 16A and 16B respectively correspond to FIGS. 10A and 10B and FIGS. 11A and 11B described in Example 1.

As shown in FIG. 8 and FIG. 15A, the adsorption start potential was −1.14 V in Example 2, −1.17 V in Comparative Example 3, and −1.12 V in Comparative Example 4. As shown in FIG. 8 and FIG. 16A, the desorption start potential was −0.732 V in Example 2, −0.370 V in Comparative Example 2, and 0.137 V in Comparative Example 4.

As shown in FIG. 8, the desorption voltage was 0.41 V in Example 2, 0.80 V in Comparative Example 3, and 1.26 V in Comparative Example 4. In Example 2, CO₂ desorption started at a lower voltage than in Comparative Examples 3 and 4.

Next, the results of measuring the CO₂ desorption efficiency of each of the electrochemical cells 101 of Example 2 and Comparative Examples 3 and 4 will be described. FIG. 12 shows the amount of CO₂ in the housing when CO₂ adsorption is performed at a constant adsorption voltage and then CO₂ desorption is performed at a constant desorption voltage on each of the electrochemical cells 101 of Example 2 and Comparative Examples 3 and 4. The adsorption voltage was −1.5 V, the desorption voltage was −0.5 V, and the adsorption time and the desorption time were each 30 minutes.

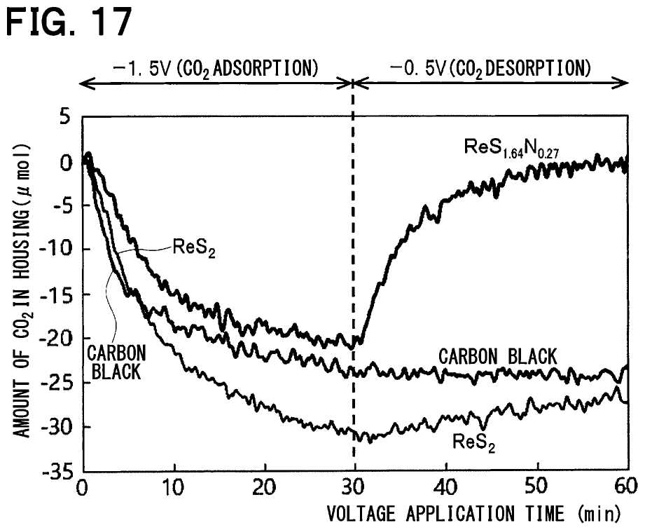

As shown in FIG. 17, when CO₂ adsorption was performed at the constant adsorption voltage (−1.5 V), the amount of CO₂ in the housing decreased in all of Example 2, Comparative Example 3, and Comparative Example 4. That is, it is considered that CO₂ adsorption was performed in all of Example 2, Comparative Example 3, and Comparative Example 4.

Next, when CO₂ desorption was performed at the constant desorption voltage (−0.5 V), the amount of CO₂ in the housing was significantly increased in Example 2, but the amount of CO₂ in the housing was slowly increased in Comparative Examples 3 and 4. That is, it is considered that, in Example 2, the adsorbed CO₂ could be efficiently desorbed, and the amount of CO₂ in the housing significantly increased, whereas, in Comparative Examples 3 and 4, the adsorbed CO₂ could not be sufficiently desorbed, and the increase in the amount of CO₂ in the housing became gentle.

As shown in FIG. 9, the CO₂ desorption efficiency was 98.1% in Example 2, 18.7% in Comparative Example 3, and 5.7% in Comparative Example 4. In Example 2, higher CO₂ desorption efficiency could be obtained than in Comparative Examples 3 and 4.

### Example 3

Next, Example 3 of the present disclosure will be described. In Example 3, Mo₂C was used as the transition metal carbide used for the CO₂ adsorbent 103b. As the electrolyte 107, [TMPA][TFSI] was used as in Example 2.

A method of producing the working electrode 103 of Example 3 will be described.

First, multi-walled carbon nanotube (CNT) powder (1 g) and MoO₃ (3.43 g) were mixed with ceramic balls and stirred at 3600 rpm for 36 hours using a ball mill. The carbon nanotubes function as the conductive assistant of the working electrode 103.

Next, the mixture was heated at 150° C. for 1 hour in an Ar atmosphere to obtain a Mo₂C-CNT powder in which Mo₂C particles were supported on the CNT powder. The Mo₂C-CNT powder was taken out from the ball mill and washed with water.

Next, 20 mg of the Mo₂C-CNT powder and 5 μL of the ethanol solution in which PTFE was dispersed were put into 10 mL of ethanol, and ultrasonic dispersion was performed for 30 minutes. Subsequently, the Mo₂C-CNT dispersion liquid was spray-coated on a carbon sheet (H-060 manufactured by Toray Industries, Inc.) and dried. As a result, Mo₂C could be generated on a surface of the carbon sheet, and the working electrode 103 of Example 3 could be manufactured.

Next, measurement results of an adsorption start potential, a desorption start potential, and a desorption efficiency when CO₂ adsorption and desorption are performed in the electrochemical cell 101 of Example 3 will be described. The adsorption start potential, the desorption start potential, and the desorption efficiency were measured in the same manner as in Example 1.

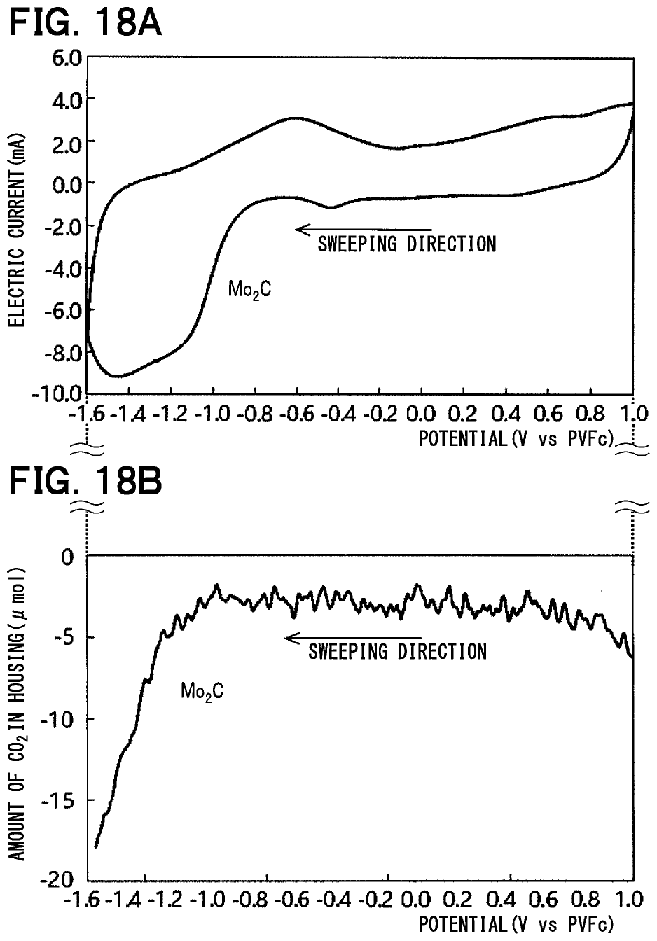

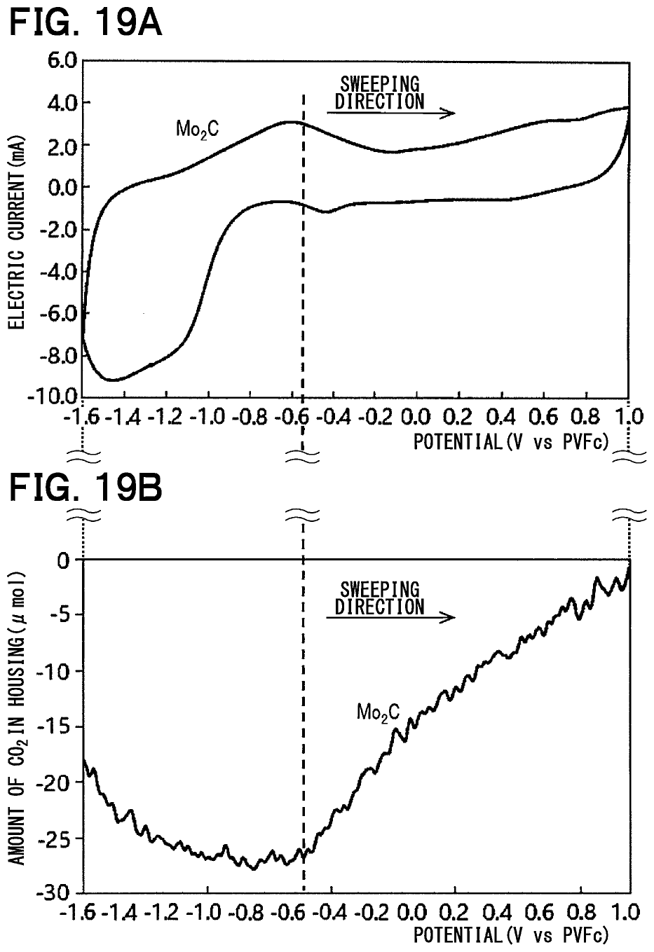

FIGS. 18A and 19B and FIGS. 19A and 19B show changes in the electric current (mA) and the amount of CO₂ (μmol) in the housing when potential sweep was performed in cyclic voltammetry measurement for the electrochemical cell 101 of Example 3. FIG. 18A and FIG. 19A show CV curves showing the change in the electric current when the potential was swept. FIG. 18B and FIG. 19B show the change in the amount of CO₂ in the housing when the potential was swept. FIGS. 18A and 18B and FIGS. 19A and 19B respectively correspond to FIGS. 10A and 10B and FIGS. 11A and 11B described in Example 1.

As shown in FIG. 8 and FIG. 18A, the adsorption start potential of Example 3 was −1.20 V. As shown in FIG. 8 and FIG. 19A, the desorption start potential of Example 3 was −0.545 V. As shown in FIG. 8, the desorption voltage of Example 3 was 0.66 V. In Example 3, CO₂ desorption started at a lower voltage than in Comparative Examples 3 and 4.

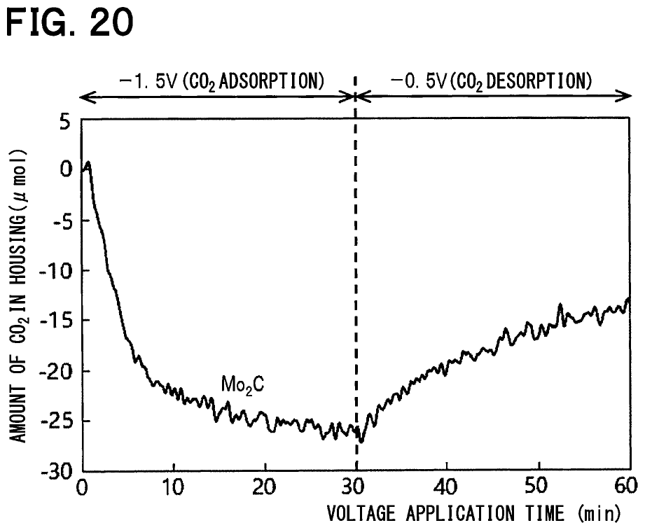

Next, the results of measuring the CO₂ desorption efficiency of the electrochemical cell 101 of Example 3 will be described. FIG. 20 shows the amount of CO₂ in the housing when CO₂ adsorption is performed at a constant adsorption voltage and then CO₂ desorption is performed at a constant desorption voltage on the electrochemical cell 101 of Example 3. The adsorption voltage was −1.5 V, the desorption voltage was −0.5 V, and the adsorption time and the desorption time were each 30 minutes.

As shown in FIG. 20, when CO₂ adsorption was performed at the constant adsorption voltage (−1.5 V), the amount of CO₂ in the housing decreased in Example 3. That is, it is considered that CO₂ adsorption was performed in Example 3.

Next, when CO₂ desorption was performed at the constant desorption voltage (−0.5 V), the amount of CO₂ in the housing significantly increased in Example 3. That is, in Example 3, it is considered that the adsorbed CO₂ can be efficiently desorbed, and the amount of CO₂ in the housing is significantly increased. As shown in FIG. 9, the CO₂ desorption efficiency of Example 3 was 50.4%. In Example 3, higher CO₂ desorption efficiency could be obtained than in Comparative Examples 3 and 4.

### Other Embodiments

The present disclosure is not limited to the embodiments described above, and various modifications can be made as follows within a range not departing from the spirit of the present disclosure. The means disclosed in the above-described embodiments may be appropriately combined to the extent practicable.

What is claimed is:

1. An electrochemical cell for separating CO₂ from a CO₂ containing gas by an electrochemical reaction, the electrochemical cell comprising:
a working electrode including a CO₂ adsorbent;
a counter electrode; and
an electrolyte covering the working electrode and the counter electrode, wherein
the working electrode and the counter electrode are configured so that electrons are supplied from the counter electrode to the working electrode and the working electrode absorbs CO₂ contained in the CO₂ containing gas in response to a first voltage applied between the working electrode and the counter electrode, and electrons are supplied from the working electrode to the counter electrode and the CO₂ is desorbed from the working electrode in response to a second voltage applied between the working electrode and the counter electrode, and
the CO₂ adsorbent is at least one selected from a group consisting of MX₂₋ₐ, MX₂Y_{1-b}, MX₂₋ₐY_{1-b}, M₂C, and M₂C_{1-d}, where
M is a transition metal,
X is any one selected from a group consisting of S, Se, and Te,
Y is an element substituting a part of X,
a is within a range of 0<a<2,
b is within a range of 0<b<1, and
d is within a range of 0<d<1.

2. The electrochemical cell according to claim 1, wherein
the CO₂ adsorbent is at least one selected from a group consisting of MX₂₋ₐ, MX₂Y_{1-b}, and MX₂₋ₐ Y_{1-b}, and
M is one selected from a group consisting of Re, Mo, Ti, Zr, Hf, V, Nb, Ta, and W.

3. The electrochemical cell according to claim 2, wherein
the CO₂ adsorbent is at least one selected from a group consisting of ReS₂₋ₐ, ReS₂N_{1-b}, and ReS₂₋ₐN_{1-b}.

4. The electrochemical cell according to claim 1, wherein
the CO₂ adsorbent is at least one selected from a group consisting of M₂C and M₂C_{1-d}, and
M is one selected from a group consisting of Mo, Ti, W, Nb, V, and Zr.

5. The electrochemical cell according to claim 4, wherein
the CO₂ adsorbent is Mo₂C.

6. The electrochemical cell according to claim 1, wherein
the electrolyte is an ionic liquid.

7. The electrochemical cell according to claim 6, wherein
the ionic liquid is aprotic.

8. The electrochemical cell according to claim 1, wherein
the working electrode is configured so that CO₂ contained in the CO₂ containing gas is adsorbed on the working electrode in a state of at least one selected from a group consisting of CO₂⁻, HCO₃⁻, and C₂O₄²⁻.
